(19) United States
(12) Patent Application Publication
(10) Pub. No.: US 2014/0118766 A1
(43) Pub. Date: May 1, 2014

(54) HOST DEVICE, DRIVING METHOD OF THE HOST DEVICE, IMAGE FORMING DEVICE, IMAGE FORMING METHOD, AND COMPUTER-READABLE RECORDING MEDIUM

(71) Applicant: Samsung Electronics Co., Ltd, Suwon-si (KR)

(72) Inventor: Kyung-hoon KANG, Suwon-si (KR)

(21) Appl. No.: 13/920,324

(22) Filed: Jun. 18, 2013

(30) Foreign Application Priority Data
Oct. 29, 2012 (KR) 10-2012-0120702

(51) Int. Cl. G06F 3/12

(52) U.S. Cl. CPC G06F 3/1297
USPC 358/1.13; 358/1.14

(57) ABSTRACT

There are provided a host device, a driving method of the host device, an image forming device, an image forming method, and a computer-readable recording medium. The host device includes a monitoring unit to monitor whether an image forming job is executed, a controller to control the host device to request an image forming device to send job table information for the image forming job, to receive the job table information from the image forming device, and to transmit a user's account information input to an interface window and job information regarding the image forming job to the image forming device, and an interface unit to request and receive the job table information, to transmit the user's account information and the job information, and to display the interface window, such that the controller requests the job table information according to the result of the monitoring by the monitoring unit.

### CROSS-REFERENCE TO RELATED APPLICATIONS

This application claims priority under 35 U.S.C. §119(a) from Korean Patent Application No. 2012-0120702, filed on Oct. 29, 2012, in the Korean Intellectual Property Office, the contents of which are incorporated herein by reference in its entirety.

### BACKGROUND OF THE INVENTION

1. Field of the Invention

The present general inventive concept relates to a host device, a driving method of the host device, an image forming device, an image forming method, and a computer-readable recording medium, and more particularly, to a host device, a driving method of the host device, an image forming device, an image forming method, and a computer-readable recording medium, to facilitate an image forming job when a program other than a driver provided by a manufacturer of the corresponding image forming device, such as APPLE'S AIRPRINT, is executed.

2. Description of the Related Art

In general, an image forming device is a device to perform a print operation based on print data created by a terminal, such as a computer, on a recording medium, such as paper. The image forming device may include a copy machine, a printer, a facsimile, a scanner, a multi-function peripheral (MFP) that is a combination thereof, etc.

Conventional image forming devices that can be connected to various mobile devices through near field communication (NFC), WiFi, or Digital Living Network Alliance (DLNA), as well as to terminals such as computers in a local network, and also may receive and print data from various mobile devices.

Lately, APPLE has introduced AIRPRINT for easily and quickly printing document on an i-Phone operating system (iOS), without supporting Common UNIX Printing System (CUPS), which is a MACINTOSH operating system (MAC OS) printing system, and has led printer manufacturers to supportAIRPRINT. MAC OS and iOS supportAIRPRINT, allowing a user to print data without utilizing a printer manufacturer's driver. AIRPRINT provides a function of wirelessly printing pictures, documents, web pages displayed through a SAFARI browser, etc., of APPLE'S smart devices, in which a 4.2 version or higher of iOS has been installed through a printer. AIRPRINT conveniently prints documents of an APPLE smart device with a few touches without installing any software or connecting a cable. Presently, AIRPRINT is being used in many printers and MFPs allowing wireless network connections.

However, when AIRPRINT has been added to a MAC OS, the corresponding terminal has been unable to provide functions such as Filter, Backend, etc., provided by a conventional manufacturer's driver, and could only use a basic user interface (UI) and functions provided by the OS, thus making data manipulations impossible.

Although general users can print data conveniently without using a specific function (e.g., BOOKLET or ECO) provided by manufacturing companies, printing becomes impossible if there is no account information when a job account is needed in a business-to-business (B2B) environment that limits image forming jobs. That is, since AIRPRINT that disallows data manipulations disables a user from inputting job account information, this is a problem particularly in a B2B environment in which the corresponding function is often used.

### SUMMARY OF THE INVENTION

The present general inventive concept provides a host device, a driving method of the host device, an image forming device, and an image forming method, to facilitate an image forming job when a program other than a driver provided by the manufacturer of the corresponding image forming device, such as APPLE'S AIRPRINT, is executed.

Additional features and utilities of the present general inventive concept will be set forth in part in the description which follows and, in part, will be obvious from the description, or may be learned by practice of the general inventive concept.

The foregoing and/or other features and utilities of the present general inventive concept are achieved by providing a host device including a monitoring unit to monitor whether an image forming job is executed, a controller to control the host device to request an image forming device to send job table information corresponding to the image forming job, to receive the job table information from the image forming device, and to transmit a user's account information input to an interface window and job information regarding the image forming job to the image forming device, and an interface unit to request and receive the job table information, to transmit the user's account information and the job information, and to display the interface window, the controller requests the job table information according to the result of the monitoring by the monitoring unit.

The monitoring unit may monitor whether there is a job that is executed by a program other than a driver provided by a manufacturing company of the image forming device.

The program may be included and implemented in an operating system (OS) of the host device.

If it is determined that the image forming job has failed based on the job table information, the controller may control the interface unit to display the interface window.

The interface unit may include a communication interface unit configured to request and receive the job table information, and to transmit the user's account information and the job information, and a user interface unit configured to display the interface window.

The user's account information may be the user's identification (ID) and a password (PW) for allowing the image forming job to be executed by the image forming device, and the job information is ID information of the image forming job.

The foregoing and/or other features and utilities of the present general inventive concept may also be achieved by providing an image forming device including a storage unit configured to store a user's account information corresponding to an image forming job, to store job table information corresponding to the image forming job, and to provide the job table information to a host device when the image forming job has failed, an interface unit configured to provide the job table information to the host device, and to receive a user's account information and job information regarding the image forming job, provided by the host device, and a controller configured to re-execute the image forming job according to the result of comparison between the received account information and the stored account information.

The image forming device may further include an account information checking unit configured to determine whether the received account information is identical to the account information stored in the storage unit, and to provide the result of the determination to the controller.

The account information may be the user's identification (ID) and a password (PW) to allow the image forming job to be executed by the image forming device, and the job information is ID information of the image forming job.

The foregoing and/or other features and utilities of the present general inventive concept may also be achieved by providing a driving method of a host device including monitoring whether an image forming job is executed, requesting an image forming device to send job table information corresponding to the image forming job, and receiving the job table information from the image forming device, displaying an interface window to receive a user's account information if it is determined that the image forming job has failed based on the job table information, and transmitting the user's account information and job information regarding the image forming job to the image forming device to re-execute the image forming job, the requesting of the job table information and the receiving of the job table information comprises requesting the job table information according to the result of the monitoring.

The monitoring of whether there is the image forming job may include monitoring whether there is a job that is executed by a program other than a driver provided by a manufacturing company of the image forming device.

The program may be included and implemented in an operating system (OS) of the host device.

The account information may be the user's identification (ID) and a password (PW) to allow the image forming job to be executed by the image forming device, and the job information is ID information of the image forming job.

The foregoing and/or other features and utilities of the present general inventive concept may also be achieved by providing an image forming method including storing a user's account information and job table information corresponding to an image forming job, and providing the job table information to a host device when the image forming job has failed, providing, at an interface unit, the job table information to the host device, and receiving a user's account information and job information regarding the image forming job, provided by the host device, and determining whether the received account information is identical to account information of the stored job table information, and re-executing the image forming job according to the result of the determination.

The account information may be the user's identification (ID) and a password (PW) to allow the image forming job to be executed by the image forming device, and the job information is ID information of the image forming job.

The foregoing and/or other features and utilities of the present general inventive concept may also be achieved by providing a computer-readable recording medium including computer-readable codes to execute a method of monitoring an image forming job , the method including monitoring whether an image forming job is executed by a program other than a driver provided by a manufacturing company of an image forming device, checking, if the image forming job is executed by the program other than the driver, a progress state of the image forming job, based on job table information corresponding to the image forming job, received from the image forming device, and stopping, if the image forming job is re-executed according to the e the image forming task, and progress status of the image forming job in the image forming device, the monitoring according to re-execution information received from the image forming device.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates an image forming system according to an exemplary embodiment of the present general inventive concept;

FIG. 2 is a block diagram illustrating a host device of FIG. 1, according to an exemplary embodiment of the present general inventive concept;

FIG. 3 is a block diagram illustrating the host device of FIG. 1, according to another exemplary embodiment of the present general inventive concept;

FIGS. 4 through 7 are views illustrating AIRPRINT as an example of a program that is executed by the host device of FIG. 1;

FIG. 8 is a view illustrating an example of using launchd to operate DAEMON to monitor in the host device of FIG. 1;

FIG. 9 is a view illustrating an example in which DevicejobMonitor has been registered in login items for monitoring in the host device of FIG. 1;

FIG. 10 is a view illustrating an example in which AIRPRINT is identified in a MAC of the host device of FIG. 1;

FIG. 11 illustrates an example of a job table stored in the image forming device of FIG. 1;

FIG. 12 illustrates an example of a UI window displayed on the host device of FIG. 1;

FIG. 13 illustrates an XML format of an account and job information input to the UI window of FIG. 11;

FIG. 14 is a block diagram illustrating the image forming device of FIG. 1;

FIG. 15 is a flowchart illustrating an image forming method according to an exemplary embodiment of the present general inventive concept;

FIG. 16 is a flowchart illustrating a driving method of the host device of FIG. 1, according to an exemplary embodiment of the present general inventive concept; and

FIG. 17 is a flowchart illustrating a driving method of the image forming device of FIG. 1, according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

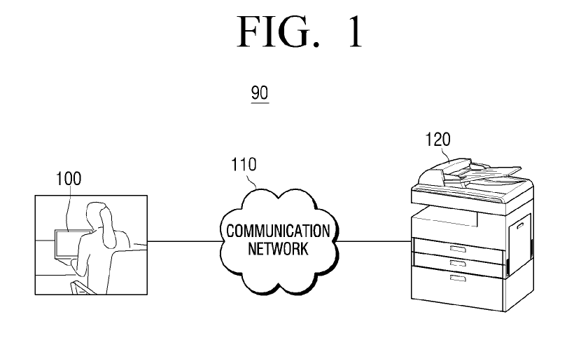

FIG. 1 illustrates an image forming system 90 according to an exemplary embodiment of the present general inventive concept.

As illustrated in FIG. 1, the image forming system 90 includes all or a part of a host device 100, a communication network 110, and an image forming device 120. According to the present general inventive concept, some or all of the components of the host device 100 can be included within the image forming device 120. In the following description, it is assumed that the image forming system 90 includes the host device 100, the communication network 110, and the image forming device 120.

The host device 100 may include a mobile terminal such as a smart phone, a notebook, a desktop computer, etc., but is not limited thereto, that can be connected to the image forming device 120 through the communication network 110. The host device 100 may have a program that is included and implemented in an operating system (OS), such as AIRPRINT. In more detail, a printing program according to an exemplary embodiment of the present general inventive concept is not necessarily included and implemented in the OS, however, the printing program may have limited functions compared to a driver provided by the manufacturing company of the image forming device 120.

For example, if the image forming device 120 is a printer, a driver opens a print panel, or a user interface (UI) window, in a document program to allow a user to set options and execute a printing operation, a spooler creates job data, a filter converts the job data into a format that can be recognized and printed by the printer, and a backend transfers the converted data to the image forming device 120. Accordingly, in an environment in which drivers are used, printer manufacturing companies provide filters and backends to convert job data from the spoolers according to the functions of the individual manufacturing companies' printers and transfer the converted data to the printers. Accordingly, if there is a job account in a B2B environment that limits image forming jobs, a filter sends job data including a header to which a user's identification (ID) and a pen width (PW) printer job language (PJL) command have been added. Meanwhile, in AIRPRINT, unlike a driver using a filter and a backend, an AIRPRINT job is created directly through an AIRPRINT framework and transferred to a printer. In other words, printers that support an AIRPRINT protocol through cooperation between APPLE and printer manufacturing companies can execute AIRPRINT jobs.

If the host device 100 executes more limited functions than conventional drivers, like AIRPRINT, the host device 100 monitors whether a printing event has occurred, brings job table information from the image forming device 120 if AIRPRINT printing has started, and checks the progress status of a job, that is, an image forming job. If it is checked that the printing has failed, the host device 100 displays a UI window to allow a user to perform data manipulation, and enables the user to input account information set by the user to allow an image forming job to be executed by the image forming device 120. The account information may be the user's ID and a password. If the account information is input, the host device 100 transfers the account information and job information (e.g., a job ID) about the corresponding image forming job to the image forming device 120 so that the image forming job can be re-executed. When printing is completed after the re-execution, the host device 100 may stop checking the progress status of the job.

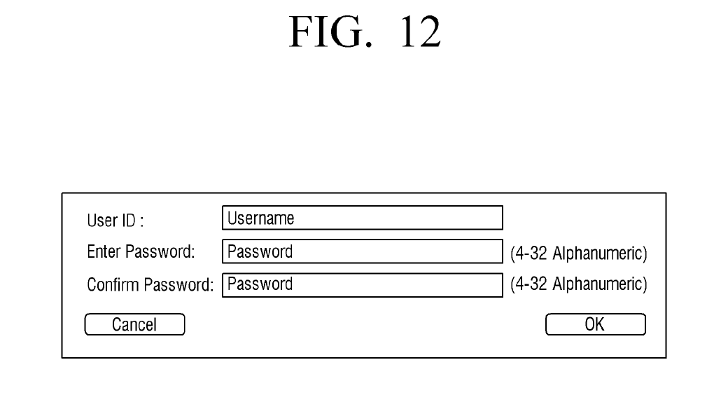

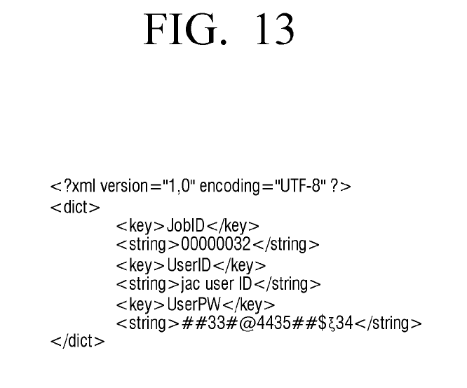

In more detail, if the job PJL header of the image forming device 120 includes no account information or includes no matching account information, a printing failure, for example, a job account failure, occurs. In this case, the host device 100 displays (e.g., pops up) a UI window to allow a user to input account information, as illustrated in FIG. 12, if its own job is determined to have failed in a job table received from the image forming device 120. Thereafter, if the user inputs account information to the UI window, the host device 100 transmits the account information and a job ID to the image forming device 120. The host device 100 may create the account information and the job ID in the format of XML as illustrated in FIG. 13, or in the format of binary data, and transmit the created account information and the job ID to the image forming device 120 through a printer channel, a Simple Network Management Protocol (SNMP), or a Hypertext Transfer Protocol (http).

The communication network 110 includes any wired or wireless communication network. Wired networks include an Internet network, such as a cable network or a public switched telephone network (PSTN), and wireless communication networks include a Code Division Multiple Access (CDMA) network, a Wideband Code Division Multiple Access (WCDMA) network, a Global System for Mobile Communications (GSM) network, an Evolved Packet Core (EPC) network, a Long Term Evolution (LTE) network, a WiBro network, etc. For example, if the communication network 110 is a wireless communication network, the host device 100 connects to a serving General Packet Radio Service (GPRS) support Node (SGSN) or a gateway GPRS support node (GGSN) to process data, or connects to various relays, such as a base transceiver station (BTS). NodeB, e-NodeB, etc. to process data.

The image forming device 120 includes a printer, a copy machine, a facsimile, a scanner, and a multi-function peripheral (MFP) that is a combination thereof. According to an exemplary embodiment of the present general inventive concept, the image forming device 120 allocates, if receiving a job from the host device 100, an ID to the corresponding job, and registers the job in a job table. Then, if the job executed in the host device 100 is an AIRPRINT job, the image forming device 120 provides the job table to the host device 100 in order to inform the host device 100 of whether the corresponding job has been successfully executed, that is, to inform the host device 100 of the progress status of the corresponding job. Although the image forming device 120 provides the job table information when the host device 100 requests it, the image forming device 120 may analyze success/failure of job execution and automatically provide the result of the analysis to the host device 100 even when there is no request from the host device 100. At this time, the image forming device 120 may provide the host device 100 with a job table indicating that the corresponding job is an AIRPRINT job.

Also, if a user's account information and a job ID are received from the host device 100, the image forming device 120 checks the received account information and re-executes a job corresponding to the job ID, thus completing printing. If the printing is complete, the image forming device 120 changes the status of the corresponding job to “complete” in the job table and stores the result. For example, the image forming device 120 may change the status of the job from “3” to “2” by changing “168.219.14.19..00000000340003” to “168.219.14.19..00000000340002.” Here, “3” may indicate a job account failure, and “2” may indicate printing completion. Then, the image forming device 120 notifies the host device 100 that printing has been completed, and allows the host device 100 to stop monitoring the image forming device 200. In order to inform the host device 100 of printing completion, the image forming device 120 may provide the corresponding information in the form of a job table.

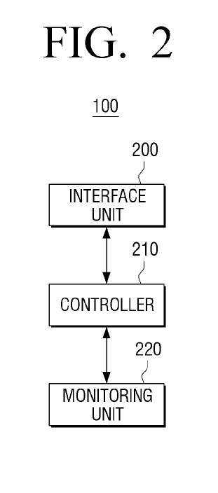

FIG. 2 is a block diagram illustrating the configuration of the host device 100 of FIG. 1, according to an exemplary embodiment of the present general inventive concept.

Referring to FIGS. 1 and 2, the host device 100 includes all or a part of an interface unit 200, a controller 210, and a monitoring unit 220. The host device 100 including all or a part of the interface unit 200, the controller 210, and the monitoring unit 220 means that some components of the host device 100 can be omitted or a component such as the monitoring unit 220 can be integrated into another component, such as the controller 210. Hereinafter, for convenience of description, it is assumed that the host device 100 includes all of the interface unit 200, the controller 210, and the monitoring unit 220.

The interface unit 200 may include at least one of a communication interface unit and a user interface unit, and the user interface unit may include at least one of a button input unit to allow a user to input user information, and a display unit. The communication interface unit corresponds to a part to communicate with the image forming device 120, and may additionally perform functions such as information conversion, etc. For example, if a user inputs account information to an interface window displayed on a user display unit, the communication interface unit may convert the account information in the format of XML or binary data to provide the account information to the image forming device 120.

The controller 210 controls the entire operation of the interface unit 200 and the monitoring unit 220 in the host device 100. In more detail, the controller 210 may determine execution of an image forming job through the monitoring unit 220, that is, determine whether an event has occurred, request the image forming device 120 to send job table information through the interface unit 200 when an event has occurred, and control the interface unit 200 to transmit a user's account information and job information input to an interface window displayed on the display unit.

The monitoring unit 220 may monitor whether a program such as AIRPRINT included and implemented in the OS of the host device 100 is executed, request the image forming device 120 to send a job table if AIRPRINT printing starts, and receive a job table from the image forming device 120 to thus check the progress status of AIRPRINT printing. At this time, the monitoring may be performed by an OS spooler. Details thereof will be described later.

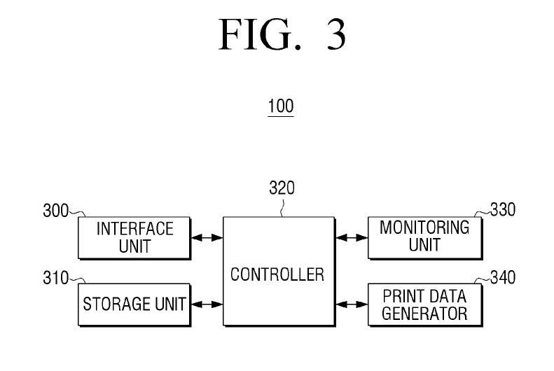

FIG. 3 is a block diagram illustrating a configuration of the host device 100 of FIG. 1, according to another embodiment of the present invention.

Referring to FIGS. 1 and 3, the host device 100 includes all or a part of an interface unit 300, a storage unit 310, a controller 320, a monitoring unit 330, and a print data generator 340. The meaning of including all or a part of components has been described above.

The storage unit 310 may store print data that is to be transmitted to the image forming device 120, as well as data that a user wants to print, under the control of the controller 320, and may store various information that is processed in the host device 100.

The print data generator 340 generates print data corresponding to the data that the user wants to print so that the print data can be provided to the image forming device 120. According to an exemplary embodiment of the present general inventive concept, the print data generator 340 stores an OS including AIRPRINT, and may execute AIRPRINT on the OS when an image forming job is executed.

The operations of the interface unit 400, the controller 320, and the monitoring unit 330 are the same as or similar to those of the interface unit 200, the controller 210, and the monitoring unit 220, and accordingly, detailed descriptions thereof will be omitted.

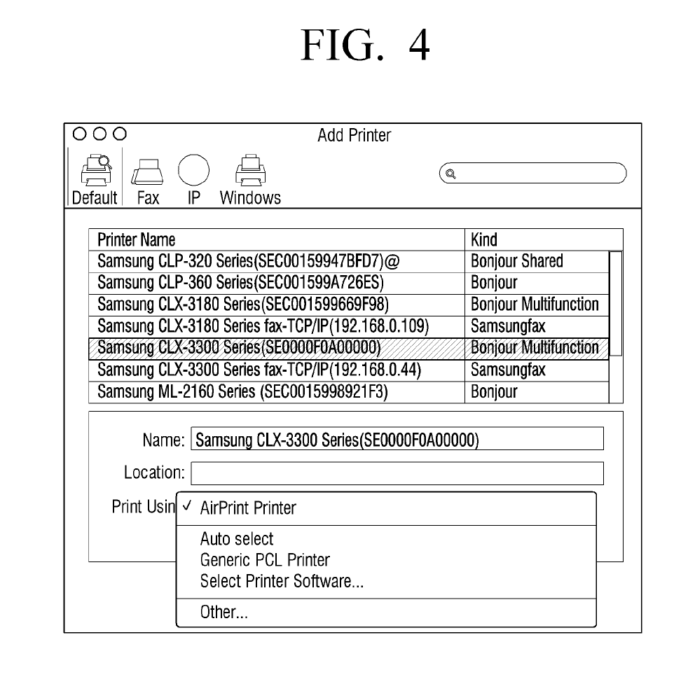

Hereinafter, referring to FIGS. 4 through 12 together with FIGS. 2 and 3, the operation of the host device 100, specifically, monitoring and re-execution of a job, will be described in detail.

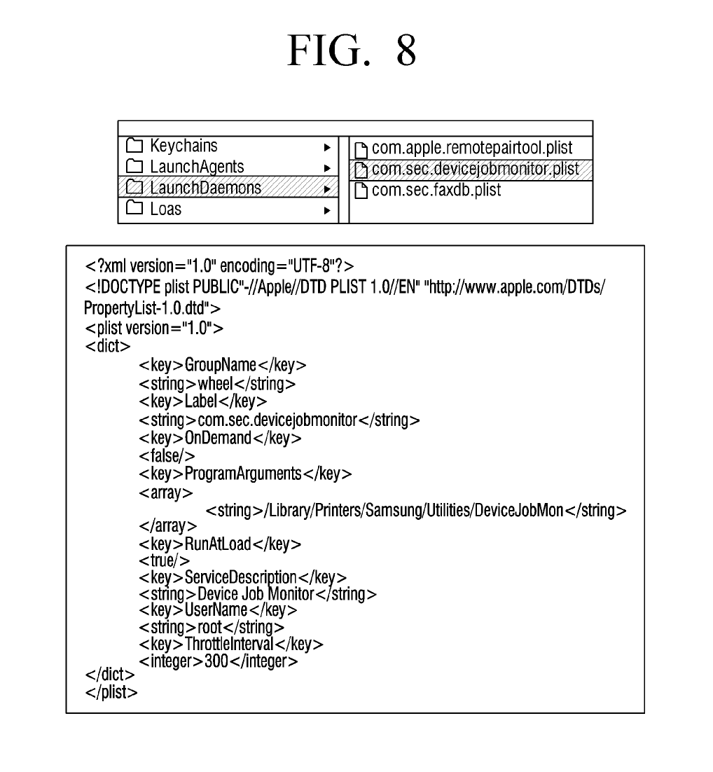

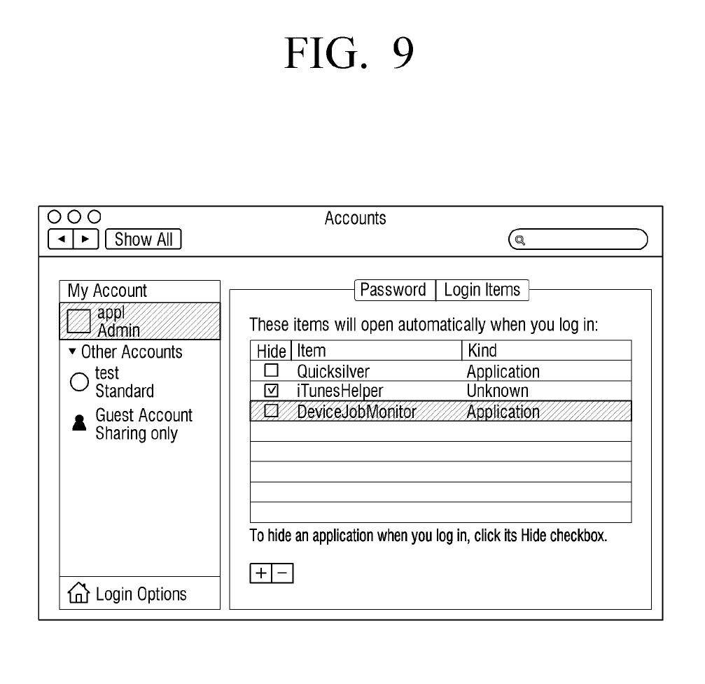

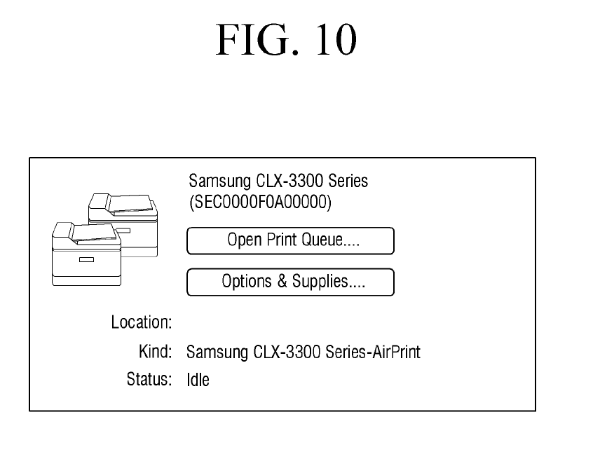

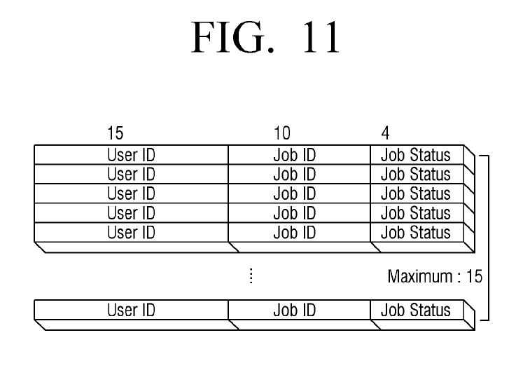

FIGS. 4 through 7 are views illustrating AIRPRINT as an example of a program that is executed by the host device 100 of FIG. 1, FIG. 8 is a view illustrating an example of using launchd to operate DAEMON to perform monitoring in the host device 100 of FIG. 1, FIG. 9 is a view illustrating an example in which DevicejobMonitor has been registered in login items to perform monitoring in the host device 100 of FIG. 1, FIG. 10 is a view illustrating an example in which AIRPRINT is identified in a media access control (MAC) of the host device 100 of FIG. 1, FIG. 11 illustrates an example of a job table stored in the image forming device 120 of FIG. 1, FIG. 12 illustrates an example of a UI window displayed on the host device 100 of FIG. 1, and FIG. 13 illustrates an XML format of an account and job information input to the UI window of FIG. 11.

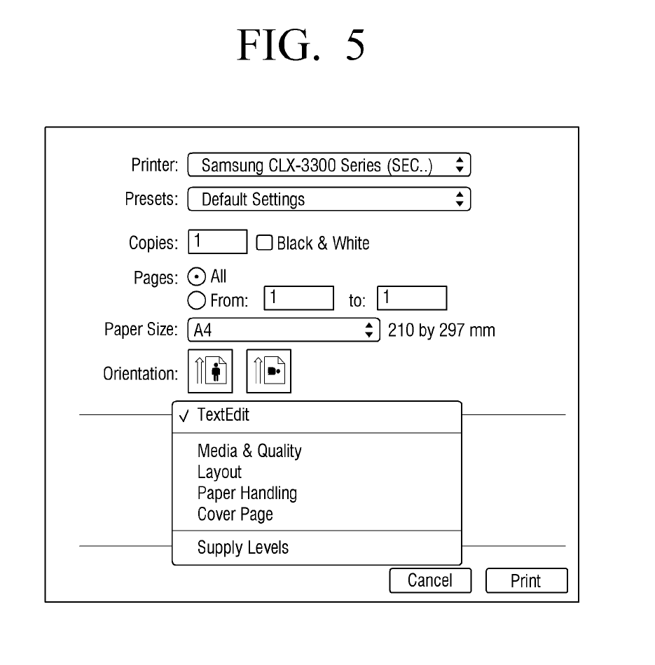

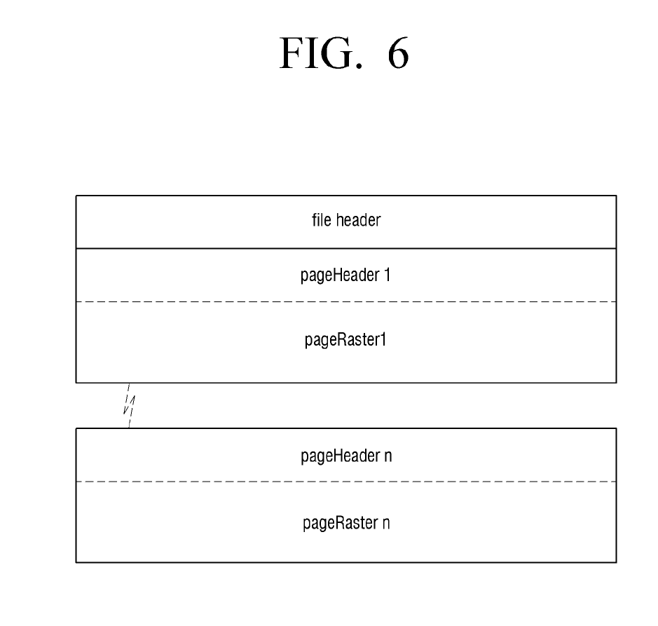

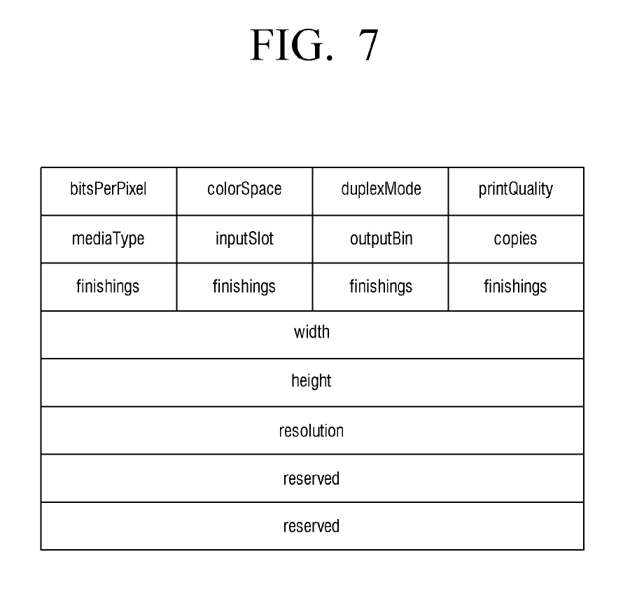

If the image forming device 120 is a printer supporting an AIRPRINT protocol, the host device 100 may add an AIRPRINT printer when a user tries to add a printer, as illustrated in FIG. 4. If an AirPrint printer is added, the user can set only basic functions, such as duplex, copy, quality, etc., defined in the AIRPRINT protocol, as illustrated in FIG. 5. This is because only a printing function has been defined in page headers, as illustrated in FIGS. 6 and 7. If the user sends a print job through AIRPRINT, the print job is directly transmitted to and printed by the printer, without being corrected or delayed by another external device. Accordingly, it is impossible to input or check job account information while a job is being transmitted. As such, if a job account has been set in the printer, a job account authentication failure necessarily occurs since the corresponding job has not been authenticated, so that the corresponding data is not printed.

In order to overcome the problem, the monitoring unit 220 or 330 of the host device 100, for example, DeviceJobMonitor is registered as DAEMON when the OS starts, and operates in the background. In order to operate as DAEMON on MAC OS, launchd of the operating DAEMON on the system level may be used, or login items of operating DAEMON on the user level may be used. As illustrated in FIG. 8, if a file defining DAEMON is stored in a folder /Library/LaunchDaemons, and the corresponding execution file is placed at a defined location, launchd reads the corresponding file and executes a process defined in the file when OS starts so that the process operates in the background. As a result, since a background process has been defined as /Library/Printers/Samsung/Utilities/DeviceJobMon, a process called DeviceJobMon is automatically created when the OS starts. The method of using login items is a method of registering login items in a user account of Account of System Preferences, and when the OS starts, a process registered in the login items is automatically executed. FIG. 9 illustrates an example in which DevicejobMonitor has been registered in login items, and in this case, when the OS starts, a DeviceJobMonitor process is automatically created and executed.

The DeviceJobMonitor registers an event handler in an OS event system to monitor an event output by a user when the OS starts. An example of registering an event handler on MAC OS is to register a handler function in a system notification center in order to receive a “com.apple.print.userDefaultPrinterChanged” notification. Whenever a user executes a printing job, the “com.apple.print.userDefaultPrinterChanged” notification is generated, and the operation of the handler is executed. If a user printing event is generated, the DeviceJobMonitor receives the user printing event from the event handler, and determines whether the corresponding job is an AIRPRINT job. The DeviceJobMonitor may determine whether the corresponding job is an AIRPRINT job by checking a type of a printer driver in which the job is executed.

An example of identifying an AIRPRINT job on MAC OS is to bring a list of printer drivers registered in an OS print spooler, and to acquire a location, a type, and status information of each printer driver, as illustrated in FIG. 10. If the status information indicates “Used” and not “Idle” and the kind information includes “AirPrint,” it can be recognized that an AIRPRINT job has been executed.

If the printer driver is not in an Idle status when a job is sent, it indicates the state in which the job is currently being sent. In this state, the job is not registered in a job table since the corresponding printer has not completely received the job. Accordingly, the DeviceJobMonitor waits until the printer driver goes to an Idle status. If a job has been completely sent and the printer driver has gone to an Idle status, the DeviceJobMonitor can request the printer to send the job table.

If receiving a job from the host device 100, the image forming device 120 allocates a job ID to the job and registers the job ID in the job table. If the job is an AIRPRINT job, the DeviceJobMonitor acquires the job table showing the statuses of individual jobs from the image forming device 120 in order to determine whether the job is successful in the image forming device 120. The job table may be acquired using a protocol, such as tcp, udp, etc. For example, object identifiers for job tables are defined, and then a job table as illustrated in FIG. 11 may be acquired through SNMP.

As illustrated in FIG. 11, a job table includes a user ID part to identify host devices, a job ID part, and a job status part. For example, if information “168.219.14.19..00000000340001” has been stored in the job table, it means that a job has been received from the host device 100 corresponding to “168.219.14.19,” the job has been allocated a job ID of “34,” and the current status of the job is “1,” that is, the job is being printed. Job statuses may be defined as numerals. For example, a status in which a job is currently being printed may be defined as “1,” a status in which a job has been completely printed may be defined as “2,” and a status in which a job account failure occurs may be defined as “3.”

The DeviceJobMonitor, which monitors a job table when an AIRPRINT job starts, recognizes the corresponding job as an AIRPRINT job when its own IP is included in the user ID part of the current job table and the job is being printed or a job account failure occurs. As another method, if a job is received through an AIRPRINT protocol, information such as “168.219.14.19..00000000340001” may be defined so that the image forming device 120 can identify an AIRPRINT job based on a job ID. That is, a symbol A is added to a job ID area in order to enable the image forming device 120 to identify the corresponding job as an AIRPRINT job.

In summary, if a job table is received, the host device 100 checks the job table to determine whether a job account failure has occurred. A job account failure occurs when the job PJL header of the image forming device 120 includes no account information or includes no matching account information. If the DeviceJobMonitor determines that its own job corresponds to a job account failure based on the job table, the DeviceJobMonitor pops up a UI window as illustrated in FIG. 12 in order to allow a user to input account information.

Thereafter, if a user inputs account information, the DeviceJobMonitor transmits the account information and a job ID to the image forming device 120. At this time, the account information and the job ID may be converted into the format of XML as illustrated in FIG. 13 and transmitted, or may be created in a form of binary data and transmitted to the image forming device 120 through a printer channel, SNMP, or http. Subsequently, if the DeviceJobMonitor determines that printing has been completed, the DeviceJobMonitor stops checking the status of the job.

The operation of the host device 100, as described above with reference to FIGS. 4 and 13, may be implemented by executing a program stored in the monitoring unit 220 or 330 of FIG. 2 or FIG. 3. Accordingly, the monitoring unit 220 or 330 may store the corresponding program in the form of a recording medium, and execute the stored program.

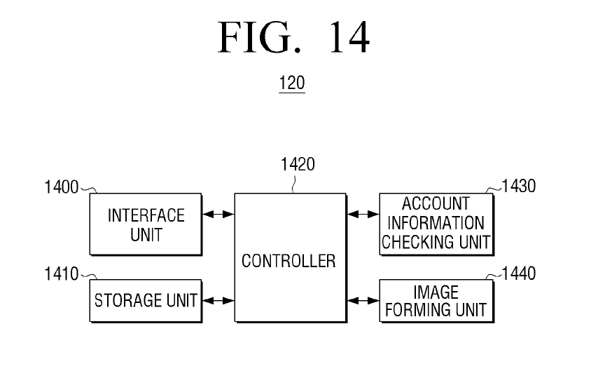

FIG. 14 is a block diagram illustrating the configuration of the image forming device 120 of FIG. 1.

Referring to FIGS. 1 and 14, the image forming device 120 may include all or a part of an interface unit 1400, a storage unit 1410, a controller 1420, an account information checking unit 1430, and an image forming unit 1440, and may further include an ID allocation unit.

The meaning of including all or a part of components has been described above.

The interface unit 1400 corresponds to a part to communicate with the host device 100, may receive print data, a user's account information, etc. from the host device 100, and may transmit job table information stored in the storage unit 1410 to the host device 100.

The storage unit 1410 creates a job table regarding a job executed by the host device 100, and in the job table, a job ID matching the job is stored. For example, a job received through the interface unit 1400 may be allocated an ID by the ID allocation unit, and then stored in the storage unit 1410.

The controller 1420 controls the operation of the interface unit 1400, the storage unit 1410, the account information checking unit 1430, the image forming unit 1440, etc. in the image forming device 120. For example, the controller 1420 may function to transfer print data received through the interface unit 1400 to the image forming unit 1440, transfer a user's account information received through the interface unit 1400 to the account information checking unit 1430, and provide job table information of the storage unit 1410 to the interface unit 1400. Also, the controller 1420 may control the image forming unit 1440 to re-execute a failed image forming job according to the results of checking by the account information checking unit 1430.

The account information checking unit 1430 may receive account information input by a user from the interface unit 1400 under the control of the controller 1420, and compare the received account information to the job table information stored in the storage unit 1410 to thus identify the user. Then, the account information checking unit 1430 provides the result of the identification to the controller 1420 so that the corresponding job can be re-executed.

The image forming unit 1440 may include a print engine. The image forming unit 1440 drives the print engine under the control of the controller 1420 to perform an image forming job. The image forming job includes printing, scanning, faxing, copying, etc., but is not limited thereto.

Although not illustrated in the drawings, the ID allocation unit receives a job executed by the host device 100 through the interface unit 1400, and allocates an ID to the received job so that Information about the job with the ID can be stored in the storage unit 1410.

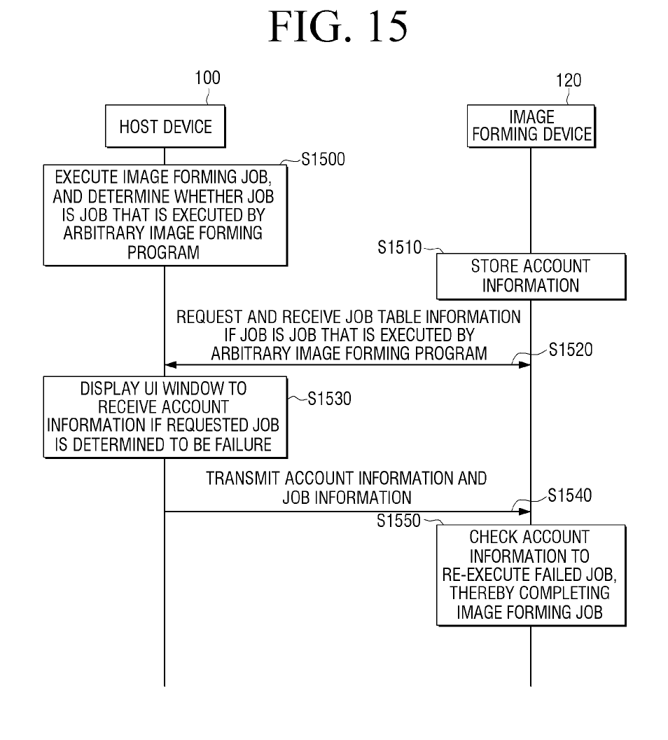

FIG. 15 is a flowchart illustrating an image forming method according to an exemplary embodiment of the present general inventive concept.

For convenience of description, referring to FIGS. 1 and 15, the host device 100 executes an image forming job, and determines whether the job is a job that is executed by an arbitrary image forming program (S1500). The determination can be understood to be a monitoring operation, and the arbitrary image forming program can be understood to be a program with limited functions compared to drivers provided by conventional printer manufacturing companies, such as APPLE'S AIRPRINT.

If the job is executed, the image forming device 120 may store information about the job in a job table (S1510). At this time, the image forming device 120 allocates an ID to the job, and then stores the job ID together with information about the job in the job table. Also, if the image forming device 120 is used in a B2B environment to limit image forming jobs, the image forming device 120 may store a user's account information in advance therein.

Also, if it is determined that the job is a job that is executed by the arbitrary image forming program, for example, by AIRPRINT, the host device 100 requests the image forming device 120 to send job table information, and receives job table information from the image forming device 120 (S1520).

Thereafter, the host device 100 checks the job table, and if the progress status of the corresponding job is determined to be a failure, the host device 100 pops up a UI window to receive a user's account information (S1530).

If a user inputs his or her account information to the UI window, the host device 100 transmits the information about the job together with the account information to the image forming device 120 (S1540). At this time, the host device 100 may convert the corresponding account information, or both the account information and the information about the job in the format of XML or binary data, and transmit the converted information to the image forming device 120.

Successively, the image forming device 120 checks the account information to re-execute a failed job according to the result of the checking, thereby completing the image forming job (S1550). In other words, the image forming device 120 compares the account information input to the host device 100 by the user to account information stored in a memory to determine whether the user is an authorized user, and re-executes the job if the user is determined to be an authorized user.

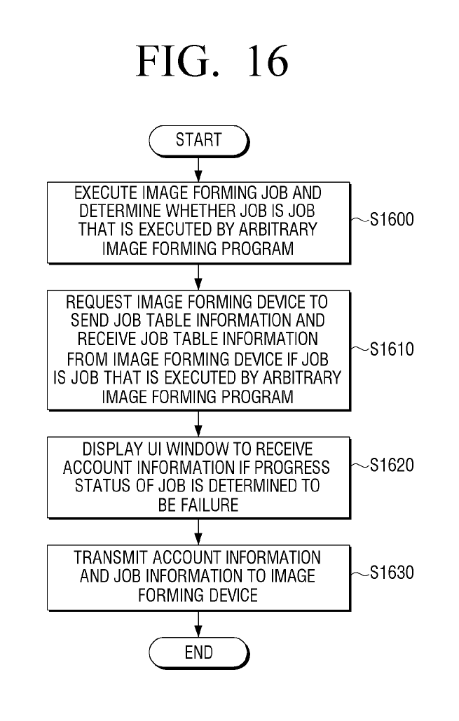

FIG. 16 is a flowchart illustrating a driving method of the host device 100 of FIG. 1, according to an exemplary embodiment of the present general inventive concept.

For convenience of description, referring to FIGS. 1 and 16, the host device 100 executes an image forming job, that is, a job requested by a user, and determines whether the corresponding job is a job that is executed by an arbitrary image forming program (S1600). Here, execution of an image forming job may mean that a print request is transmitted to the image forming device, and the arbitrary image forming program may mean a program with limited functions compared to conventional drivers, such as AIRPRINT, as described above.

Successively, if the job is a job that is executed by the arbitrary image forming program, the host device 100 requests the image forming device 120 to send a job table, and receives a job table from the image forming device 120 (S1610). The job table includes information regarding the current status of the corresponding job.

If the status of the corresponding job is determined to be a failure from the information of the job table, the host device 100 pops up a UI window to allow a user to input account information (S1620).

If a user inputs user account information, for example, the user's ID and a password, through the UI window, the host device 100 transmits information about the job together with the account information to the image forming device 120 (S1630).

As a result, the image forming device 120 compares the received user account information with pre-stored user account information, and re-executes the corresponding job if the received user account information is identical to the pre-stored user account information, thereby completing the image forming job.

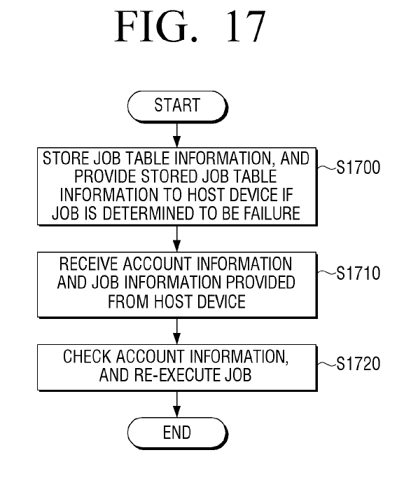

FIG. 17 is a flowchart illustrating a driving method of the image forming device 120 of FIG. 1, according to an exemplary embodiment of the present general inventive concept.

For convenience of description, referring to FIGS. 1 and 17, the image forming device 120 stores job table information corresponding to an image forming job, that is, a job requested by a user from the host device 100, and provides the stored job table information to the host device 100 if the corresponding job has failed (S1700). If the image forming device 120 is applied to a B2B environment that limits printing of an image forming job, the image forming device 120 may store account information, such as users' IDs or passwords, in advance.

Successively, the image forming device 120 may receive account information and job information provided from the host device 100 (S1710). In other words, the host device 100 checks the received job table information to determine whether the requested job has failed, and if it is determined that the job has failed, the host device 100 transmits a user's account information input to a UI window displayed on a screen, and job information about the corresponding job to the image forming device 120.

Then, the image forming device 120 may compare the received account information to account information stored in a memory that is a storage unit to determine whether the received account information is identical to the stored account information, and re-execute the corresponding job if the received account information is identical to the stored account information (S1720). Thereby, the image forming device 120 may complete an image forming job, such as printing or scanning.

An example in which the image forming device 120 uses a job account to print data has been described. However, the present general inventive concept may include additionally specialized functions of a manufacturing company, which are not supported by AIRPRINT. In other words, as long as job execution of the image forming device 120 is limited by an arbitrary image forming program such as AIRPRINT, the image forming device 120 may re-execute a job by exchanging information with the host device 100 in various manners.

Also, the image forming device 120 may pause an AIRPRINT job when receiving the AirPrint job, instead of directly outputting the AIRPRINT job, acquire status information of the AIRPRINT job from DeviceJobMonitor, and pop up a UI window to allow a user to set an additional option if the corresponding job has been paused. Here, the additional option may be an option that is not supported by AIRPRINT, such as Booklet, margin adjustment, poster printing, etc. If the user adjusts the option, information about the adjusted option is transferred to the corresponding function block, and the paused AIRPRINT job may be resumed according to the option.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A host device, comprising:
a monitoring unit to monitor whether an image forming job is executed;
a controller to control the host device to request an image forming device to send job table information corresponding to the image forming job, to receive the job table information from the image forming device, and to transmit a user's account information input to an interface window and job information regarding the image forming job to the image forming device; and
an interface unit to request and receive the job table information, to transmit the user's account information and the job information, and to display the interface window,
wherein the controller requests the job table information according to the result of the monitoring by the monitoring unit.

2. The host device of claim 1, wherein the monitoring unit monitors whether there is a job that is executed by a program other than a driver provided by a manufacturing company of the image forming device.

3. The host device of claim 2, wherein the program is included and implemented in an operating system (OS) of the host device.

4. The host device of claim 1, wherein, if it is determined that the image forming job has failed by checking the job table information, the controller controls the interface unit to display the interface window.

5. The host device of claim 1, wherein the interface unit comprises:
a communication interface unit configured to request and receive the job table information, and to transmit the user's account information and the job information; and
a user interface unit configured to display the interface window.

6. The host device of claim 1, wherein the user's account information is the user's identification (ID) and a password (PW) for allowing the image forming job to be executed by the image forming device, and
the job information is ID information of the image forming job.

7. An image forming device comprising:
a storage unit configured to store a user's account information corresponding to an image forming job, to store job table information corresponding to the image forming job, and to provide the job table information to a host device when the image forming job has failed;
an interface unit configured to provide the job table information to the host device, and to receive a user's account information and job information regarding the image forming job, provided by the host device; and
a controller configured to re-execute the image forming job according to the result of comparison between the received account information and the stored account information.

8. The image forming device of claim 7, further comprising an account information checking unit configured to determine whether the received account information is identical to the account information stored in the storage unit, and to provide the result of the determination to the controller.

9. The image forming device of claim 7, wherein the account information is the user's identification (ID) and a password (PW) to allow the image forming job to be executed by the image forming device, and
the job information is ID information of the image forming job.

10. A driving method of a host device, comprising:
monitoring whether an image forming job is executed;
requesting an image forming device to send job table information corresponding to the image forming job, and receiving the job table information from the image forming device;
displaying an interface window to receive a user's account information if it is determined that the image forming job has failed based on the job table information; and
transmitting the user's account information and job information regarding the image forming job to the image forming device to re-execute the image forming job,
wherein the requesting of the job table information and the receiving of the job table information comprises requesting the job table information according to the result of the monitoring.

11. The driving method of claim 10, wherein the monitoring of whether there is the image forming job comprises monitoring whether there is a job that is executed by a program other than a driver provided by a manufacturing company of the image forming device.

12. The driving method of claim 11, wherein the program is included and implemented in an operating system (OS) of the host device.

13. The driving method of claim 10, wherein the account information is the user's identification (ID) and a password (PW) to allow the image forming job to be executed by the image forming device, and
the job information is ID information of the image forming job.

14. An image forming method, comprising
storing a user's account information and job table information corresponding to an image forming job, and providing the job table information to a host device when the image forming job has failed;
providing, at an interface unit, the job table information to the host device, and receiving a user's account information and job information regarding the image forming job, provided by the host device; and
determining whether the received account information is identical to account information of the stored job table information, and re-executing the image forming job according to the result of the determination.

15. The image forming method of claim 14, wherein the account information is the user's identification (ID) and a password (PW) to allow the image forming job to be executed by the image forming device, and
the job information is ID information of the image forming job.

16. A non-transitory computer-readable recording medium including computer-readable codes to execute a method of monitoring an image forming job, the method comprising:
monitoring whether an image forming job is executed by a program other than a driver provided by a manufacturing company of an image forming device;
checking, if the image forming job is executed by the program other than the driver, a progress state of the image forming job, based on job table information corresponding to the image forming job, received from the image forming device; and
stopping, if the image forming job is re-executed according to the progress status of the image forming job in the image forming device, the monitoring according to re-execution information received from the image forming device.
